(19) United States
(12) Patent Application Publication
(10) Pub. No.: US 2014/0031020 A1
(43) Pub. Date: Jan. 30, 2014

(54) HOME PHONE SYSTEM, HOME PHONE, AND COMMUNICATION METHOD

(71) Applicant: HON HAI PRECISION INDUSTRY CO., LTD., New Taipei (TW)

(72) Inventor: CHIH-YUAN YANG, New Taipei (TW)

(73) Assignee: HON HAI PRECISION INDUSTRY CO., LTD., New Taipei (TW)

(21) Appl. No.: 13/869,970

(22) Filed: Apr. 25, 2013

(30) Foreign Application Priority Data
Jul. 27, 2012 (CN) 2012102640554

(51) Int. Cl. H04W 4/16

(52) U.S. Cl. CPC H04W 4/16
USPC 455/417

(57) ABSTRACT

The disclosure includes a home phone system, a home phone, and a communication method for the home phone. The system includes a home phone connected with a wired telephone communication system. The method includes: establishing a wireless network associated with a predefined privilege coverage area, setting at least one ID code in the coverage area, and endowing each ID card with one ID code; detecting an incoming call of a calling party via the wired telephone communication system and converting analog signals of the incoming call into digital signals; sending the digital signals to each mobile phone inserted into the ID card; and converting audio signals received from the mobile phone into analog signals, and transmitting the analog signals to the wired telephone communication system and establishing a call link.

### BACKGROUND

1. Technical Field

The disclosure relates to a phone system and, more particularly, to a home phone system, a home phone, and a communication method adapted for the home phone system.

2. Description of Related Art

People often replace an older mobile phone with a new one, so there may be a lot of unused mobile phones in a family. Therefore, the mobile phones that are not used by users are a being wasted.

Therefore, what is needed is a home phone system to overcome the described shortcoming

### BRIEF DESCRIPTION OF THE DRAWINGS

FIG. 1 is a schematic view of a home phone system in accordance with an exemplary embodiment.

FIG. 2 is a block diagram of a home phone of the home phone system of FIG. 1.

FIG. 3 is a block diagram of a control unit of the home phone of FIG. 2.

FIG. 4 is a flowchart of a communication method adapted for the home phone system of FIG. 1.

### DETAILED DESCRIPTION

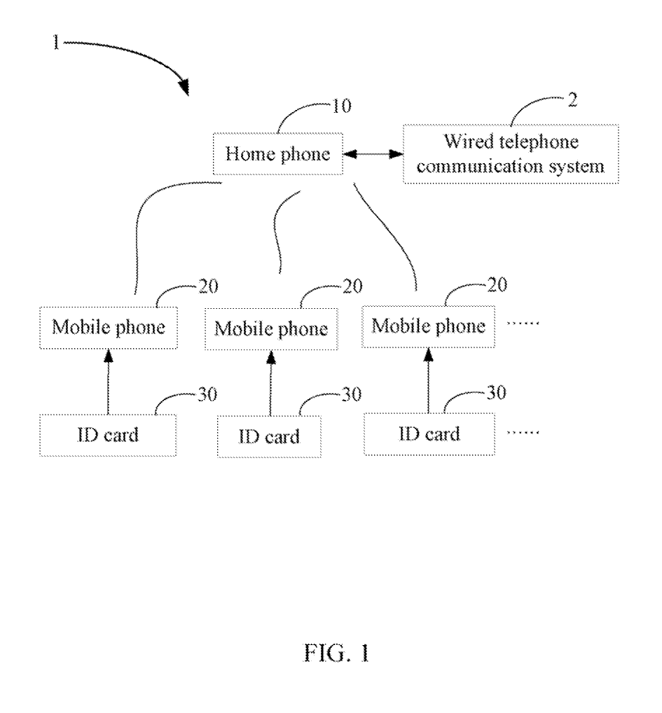

FIG. 1 is a schematic view of a home phone system 1 in accordance with an exemplary embodiment. The home phone system 1 includes a home phone 10, at least one mobile phone 20, and at least one identification (ID) card 30. The home phone 10 is connected with a wired telephone communication system 2 via wires and is located in a house. The at least one ID card 30 can be inserted into the mobile phone 20 and the mobile phone 20 can identify the inserted ID card 30.

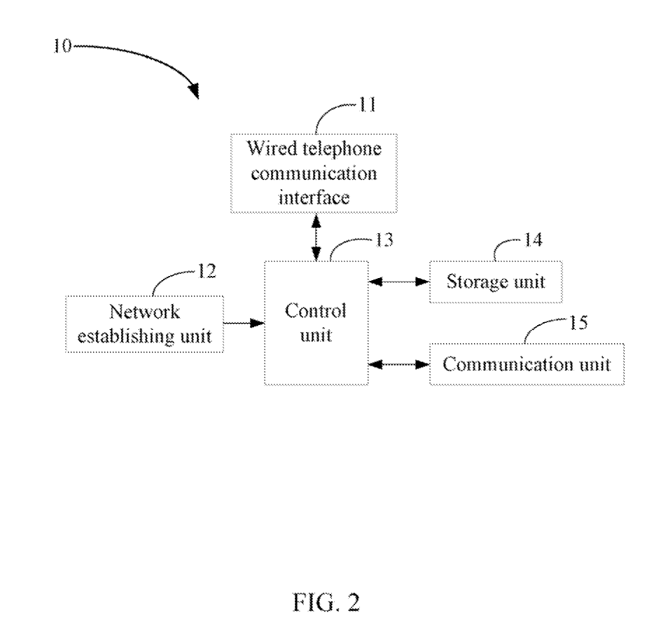

FIG. 2 shows that the home phone 10 includes a wired telephone communication interface 11, a network establishing unit 12, a control unit 13, a storage unit 14, and a communication unit 15. The wired telephone communication interface 11 connects the home phone 10 with the wired telephone communication system 2 via wire. The network establishing unit 12 establishes a wireless network associated with a predefined privilege coverage area, sets at least one ID code in the coverage area, and assigns the ID card 30 with the ID code. The control unit 13 controls the home phone 10 and the at least one mobile phone 20 to communicate with the wired telephone communication system 2. The storage unit 14 stores the at least one ID code. The communication unit 15 receives and sends wireless signals.

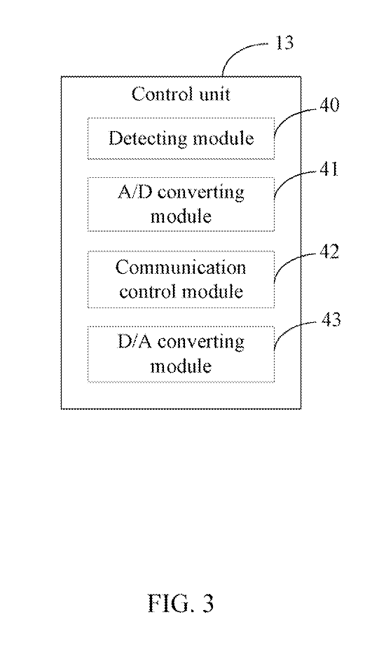

FIG. 3 shows that the control unit 13 further includes a detecting module 40, an analog-digital (A/D) converting module 41, a communication control module 42, and a digital-analog (D/A) converting module 43. The at least one ID card 30 is inserted into the mobile phones 20. The detecting module 40 detects an incoming call of a calling party via the wired telephone communication system 2 in real time, then the A/D converting module 41 converts the analog signals of the incoming call into digital signals. The communication control module 42 controls the communication unit 15 to send the digital signals to each mobile phone 20 with the ID card 30 in the coverage area. Each mobile phone 20 generates an incoming call prompt in response to the incoming call, such as a ring tone, and a user can answer the incoming call by using one of the at least one mobile phone 20, therefore, the mobile phone 20 replaces a conventional cordless phone.

When the user of the mobile phone 20 speaks, the communication unit 15 receives audio signals from the mobile phone 20 responding to the incoming call and the D/A converting module 43 converts the audio signals from the mobile phone 20 into analog signals. The communication control module 42 transmits the analog signals to the wired telephone communication system 2 and establishes a call link between the calling party and the mobile phone 20.

When the user wants to place a call, the mobile phone 20 is used to generate a dial number signal in response to user inputs, the communication unit 15 receives the dial number signal and then the D/A converting module 43 converts the dial number signal from the mobile phone 20 into analog signals. The communication control module 42 transmits the analog signals to the wired telephone communication system 2 and establishes a call link between the called party and the mobile phone 20.

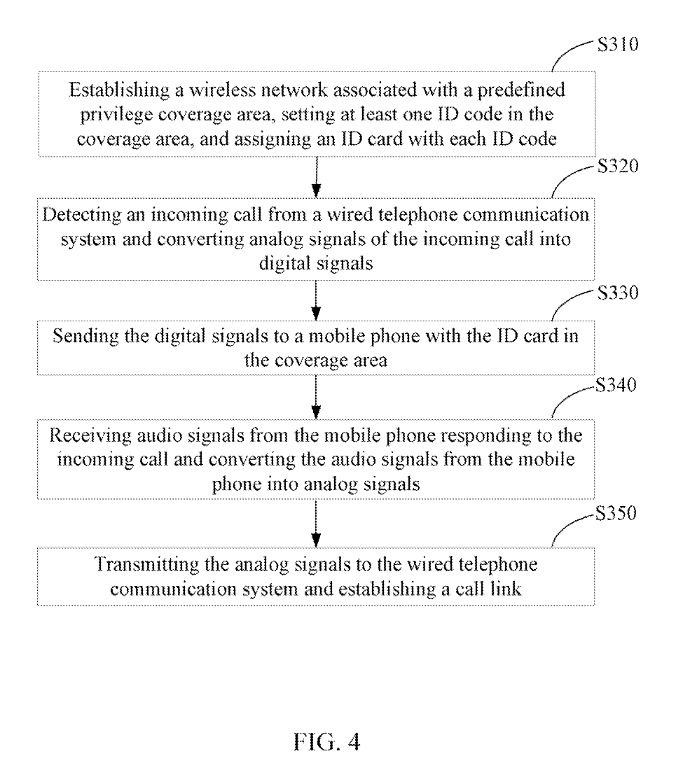

FIG. 4 is a flowchart of a communication method adapted for the home phone system of FIG. 1.

In step S310, the network establishing unit 12 establishes a wireless network associated with a predefined privilege coverage area, sets at least one ID code in the coverage area, and assigns an ID card 30 with each ID code.

In step S320, the detecting module 40 detects an incoming call of a calling party via the wired telephone communication system 2 and the A/D converting module 41 converts analog signals of the incoming call into digital signals.

In step S330, the communication control module 42 controls the communication unit 15 to send the digital signals to each mobile phone 20 with the ID card 30 in the coverage area.

In step S340, the communication unit 15 receives audio signals from the mobile phone 20 responding to the incoming call and the D/A converting module 43 converts the audio signals from the mobile phone 20 into analog signals.

In step S350, the communication control module 42 transmits the analog signals to the wired telephone communication system 2 and establishes a call link between the calling party and the mobile phone 20.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A home phone system comprising:
a home phone connected with a wired telephone communication system via wires;
at least one mobile phone; and
at least one identification (ID) card inserted into the at least one mobile phone;
the home phone comprising:
a network establishing unit to establish a wireless network associated with a predefined privilege coverage area, set at least one ID code in the coverage area, and assign each of the at least one ID card with one of the at least one ID code;
a storage unit to store the at least one ID code;
a communication unit to receive and send wireless signals; and
a control unit to detect an incoming call of a calling party via the wired telephone communication system, convert analog signals of the incoming call into digital signals, control the communication unit to send the digital signals to each mobile phone with the ID card in the coverage area, convert audio signals received from the mobile phone into analog signals in response to the incoming call, and transmit the analog signals to the wired telephone communication system and establish a call link between the calling party and the mobile phone.

2. The home phone system as recited in claim 1, wherein when the home phone receives audio signals of the calling party, the control unit is further configured to convert the audio signals to digital signals and control the communication unit to send the digital signals to the mobile phone.

3. A home phone connected with a wired telephone communication system via wires, the home phone comprising:
a network establishing unit to establish a wireless network associated with a predefined privilege coverage area, set at least one ID code in the coverage area, and assign each of the at least one ID card with one of the at least one ID code;
a storage unit to store the at least one ID code;
a communication unit to receive and send wireless signals; and
a control unit to detect an incoming call of a calling party via the wired telephone communication system, convert analog signals of the incoming call into digital signals, control the communication unit to send the digital signals to each mobile phone with the ID card in the coverage area, convert audio signals received from the mobile phone into analog signals in response to the incoming call, and transmit the analog signals to the wired telephone communication system and establish a call link between the calling party and the mobile phone.

4. The home phone as recited in claim 3, wherein when receiving audio signals of the calling party, the control unit is further configured to convert the audio signals to digital signals and control the communication unit to send the digital signals to the mobile phone.

5. A communication method for a home phone system, wherein the home phone system comprises a home phone connected with a wired telephone communication system via wire, at least one mobile phone, and at least one identification (ID) card inserted into the at least one mobile phone; the method comprising:
establishing a wireless network associated with a predefined privilege coverage area, setting at least one ID code in the coverage area, and assigning each of the at least one ID card with one of the at least one ID code;
detecting an incoming call of a calling party via the wired telephone communication system and converting analog signals of the incoming call into digital signals;
sending the digital signals to each mobile phone with the ID card in the coverage area; and
converting audio signals received from the mobile phone into analog signals in response to the incoming call, and transmitting the analog signals to the wired telephone communication system and establishing a call link between the calling party and the mobile phone.

6. The communication method as recited in claim 5, further comprising:
receiving audio signals of the calling party, converting the audio signals to digital signals and sending the digital signals to the mobile phone.
